(19) United States
(12) Patent Application Publication
(10) Pub. No.: US 2002/0112002 A1
(43) Pub. Date: Aug. 15, 2002

(54) System and process for creating a virtual stage and presenting enhanced content via the virtual stage

(76) Inventor: Michael R. Abato, White Plains, NY (US)

Correspondence Address: DORSEY & WHITNEY, LLP, SUITE 4700, 370 SEVENTEENTH STREET, DENVER, CO, 80202-5647, US

(21) Appl. No.: 10/076,689

(22) Filed: Feb. 14, 2002

Related U.S. Application Data
(60) Provisional application No. 60/269,592, filed on Feb. 15, 2001.

(51) Int. Cl. G06F 15/16; H04N 7/16; G06F 9/00; G06F 9/46

(52) U.S. Cl. 709/203; 709/219; 709/205; 725/136; 709/328

(57) ABSTRACT

A system and process for creating a Virtual Stage on a client device and presenting Enhanced Content on the Virtual Stage is provided. The Virtual Stage is preferably implemented on a Browser or similarly equipped presentation device. The Virtual Stage enables any presentation device to receive Enhanced Content from any provider regardless of the capabilities of the Browser or client device, the data format of the Enhanced Content, and/or the communications medium utilized to communicate the Enhanced Content to the Browser or client device. The Virtual Stage suitably includes an abstracted Show Object which provides a framework for presenting the Enhanced Content and an abstracted Receiver Object which provides a receiver for communicating with the Enhanced Content provider and receiving the Enhanced Content. Alternative embodiments may also include multiple abstracted Receiver Objects and/or abstracted Subscribers, which facilitates communications with subscription service provider systems, including, but not limited to, chat service systems.

### REFERENCE TO RELATED APPLICATIONS

This application claims priority to and incorporates by reference, in its entirety, U.S. provisional application serial No. 60/269592, by Michael R. Abato, entitled “A SYSTEM AND METHOD FOR PRESENTING CONTENT RELATED TO A TEMPORAL EVENT TO A USER VIA A VIRTUAL STAGE” which was filed on Feb. 15, 2001. The present application is also related to the following applications, which are incorporated, in their entirety, herein by reference: U.S. application serial No. 09/396,693 of Craig D. Ullman, Michael R. Abato, Jeffrey M. Harrington, and Carl R. Duda, entitled “ENHANCED VIDEO PROGRAMMING SYSTEM AND METHOD FOR PROVIDING A DISTRIBUTED COMMUNITY NETWORK,” and filed on Sep. 15, 1999 (hereafter, the “DCN application”); and U.S. provisional application serial No. 60/269,593 of Jeffrey M. Harrington, entitled “A SYSTEM AND METHOD FOR SERVER SIDE CONTROL OF FLASH,” and filed on Feb. 15, 2001 (hereinafter, the “FLASH application”).

### BACKGROUND OF THE INVENTION

Today, the capabilities of computers to provide massive amounts of educational and entertainment information has exploded with the Internet. The Internet has the power to transform society through unprecedented levels of information flow between members. Currently, on-line systems offer a variety of different services to users, including news feeds, electronic databases (either searchable by the user directly on the on-line system, or downloadable to the user's own computer), private message services, electronic newsletters, real-time games for play by several users at the same time, and job placement services, to name a few. However, today, most on-line communications occur merely through text. This currently stands in great contrast to the audio/visual presentation of the alternative electronic medium, television. However, it is expected that as multi-media's incessant growth continues, audio/visual programs will proliferate and text will become less and less dominant in the on-line environment. Even though these programs will be introduced, the Internet will remain essentially user unfriendly due to its very massiveness, organization and randomness. Simply stated, there is no order or direction in the Internet. Specific pieces of information are many times hard to find, and even harder is the ability to put that piece of information into a meaningful context.

Television, on the other hand, has been criticized for being a passive medium-“chewing gum for the eyes,” as Fred Allen once observed. Television has always been something you watched, not something you do. Many social critics believe that the passivity television depends on has seeped into our entire culture, turning a nation of citizens into a nation of viewers. While interactive television systems have increased the level of user interaction and provided greater learning and entertainment opportunities, vast information resources, such as databases, are inaccessible from such a medium.

Recent innovations in combining Internet content with television and other audio and/or video programming signals have been described in various patents and publications, for example, U.S. Pat. No. 5,778,181, which issued on Jul. 7, 1998 to Jack D. Hidary, et al., U.S. Pat. No. 6,018,768, issued on Jan. 25, 2000 to Craig Ullman and Jack Hidary et al., and also in U.S. Pat. No. 5,774,664, which issued on Jun. 30, 1998 to Jack D. Hidary, et al. (hereinafter, collectively the “Hidary patents”). The contents of these patents are herein incorporated by reference, in their entirety. As is now well known in the art, these patents describe innovative systems and processes for combining the user-friendly visual experience of television programming signals, and other time based events or signals, with information resources located on the Internet which relate to the programming signal (hereinafter, the “Enhanced Content”). Since segments in a programming signal are generally presented in a sequence to a client based upon a reference to a known event (for example, the amount of time remaining in a football game is based upon the kick-off, or the amount of time remaining in a recorded movie is based upon when the playback of the movie is started and not when it was actually filmed), such programming signals shall herein be regarded as applying to any signal, show, or sequence of events, whether pre-recorded or live, which are defined or based upon a temporal relationship (hereinafter, the “Temporal Signal”). Such Temporal Signals may include live events (for example, a cut-away by a television broadcaster to a then breaking news event), pre-recorded events, and combinations of live and pre-recorded events.

Recently, various approaches have been implemented for providing client side and server side systems capable of providing Enhanced Content related to a Temporal Signal. As is well known in the art, such approaches generally require a client to download (commonly from an Internet based Web site) and then install a Java applet which configures the client's system as a specific application. Another approach utilizes a client system, such as a Web Browser or an equivalent system including, but not limited to, a Flash player or an XML browser (hereinafter, collectively, a “Browser”), and a downloaded program which configures the client system to retrieve Enhanced Content over a specific type of communications link, for a specific type of client device, based upon the reception of a Temporal Signal and an address identifying a provider of Enhanced Content related thereto. Regardless of the specific methodology utilized, today's client systems commonly must execute a large download to receive and present Enhanced Content program segments which relate to a given Temporal Signal.

Further , since the Internet has innumerable sites, which a client may or may not find using a search engine, producers of Temporal Signals often identify a location providing Enhanced Content (for example, an Internet site) by presenting, in the video or audio portion of a Temporal Signal, a Uniform Resource Identifier (URI), as defined in the RFC 2396 which includes, for example, a tangible Web asset, a Uniform Resource Locator, a Uniform Resource Name, a functional push and an object push (hereinafter, collectively referred to as an “URI”). Once the site is identified by the client and/or the client's device or system (hereinafter, “client device” and “client system” are utilized interchangeably), the client system commonly registers the client with the provider of the Enhanced Content.

Following registration, the client often needs to identify a program or segment for which the client desires to receive the related Enhanced Content (since Enhanced Content for multiple programs may be accessible from a single Internet site). Once selected, the client system then often downloads and installs a Java applet, or similar program code, which configures the client device to receive the related Enhanced Content. At this point, the client system is then ready to connect to the provider of the Enhanced Content, satisfy any pre-requisites (for example, providing a password, sign-on, or user profile information), and receive the Enhanced Content.

As such, the approaches commonly utilized today to receive Enhanced Content generally require a client to first identify the location of a provider of Enhanced Content, register the client with the provider, download a program which configures the client system, installs the program, connects to a site providing Enhanced Content related to a specific Temporal Signal, and then satisfies any prerequisites prior to receiving the Enhanced Content (for example, providing user profile information). In short, these approaches require so much time and effort to configure the client system and access a provider of the Enhanced Content that many clients are discouraged from utilizing such an approach.

What is needed is a system and process which reduces and minimizes the amount of time and effort required by a client device to automatically, or upon request, receive Enhanced Content related to a Temporal Signal. What is needed is a wider, richer, quicker, and more efficient system and process for receiving and processing audio/visual and textual database elements into an organized unique interactive, educational, entertainment experience.

### SUMMARY OF THE INVENTION

Systems consistent with the present invention provide a system and process for combining Temporal Signals (which appear, for example, on a television broadcast, a VHS or Beta tape, CD-ROM, DVD, CD, or other medium) with Enhanced Content (accessible, for example, via the Internet) without requiring lengthy downloads, specific client devices or operating systems, specific data formats, or similar constraints. By abstracting the concept of a Virtual Stage which contains at least a Show Object and a Receiver Object, the present invention allows Enhanced Content to be received and processed by virtually any system regardless of configuration, device, hardware, software, communications links utilized, or practically any other factor. Preferably, such a system is implemented on a client device capable of hosting a Browser. As such, the present invention is described in the context of using a Browser for supporting its operations.

Further, the present invention creates a new, efficient, dynamic, diverse and powerful educational and entertainment medium. The system allows consumers to receive more information in a more efficient manner than either television or the Internet alone and over prior systems and processes utilized to present Enhanced Content related to a Temporal Signal. Instead of requiring client systems to execute lengthy, and sometimes problematic, downloads prior to receiving an Enhanced Content segment, the present invention streamlines such processes by removing the determination of a type of Receiver Object utilized by a client device from the initialization processes. As such, by using the new systems and processes, consumers not only can see a news report on television, but they can also read pertinent information about the report, as well as explore related information about the story regardless of the device, type of Browser or platform utilized by the client system, and/or the source of the Enhanced Content. The act of viewing a program has now become a more engaging, enriching experience, because Enhanced Content can now be obtained almost instantaneously without any lengthy downloads, initialization routines, or constraints upon compatible systems or sources.

The systems and processes of the present invention can also create a more intimate relationship between the client and the program. For example, in an educational environment, a student (the client) might be solving problems or performing virtual experiments on an Internet site that a teacher is discussing in an educational television program. Similarly, the consumer might be solving problems that the fictional characters in a television program must solve. In both cases, the consumer is an active participant in the process, rather than a passive observer. Unlike previous systems, the present invention enables the student and the teacher to visit the classroom via any client device, including the ever more increasingly popular wireless devices such as personal data assistants and wireless communications devices. Such capabilities are possible with the present invention, because the invention provides for the creation of an abstraction of a Receiver Object that allows a client device (regardless of the device's specific configuration and/or capabilities) to receive Enhanced Content without requiring those elements responsible for presenting the Enhanced Content to know from where and/or how such content was obtained. Instead of the entire Browser or a specific application software being concerned with when and how Enhanced Content segments are received, in the present invention, only an abstracted Receiver Object (i.e., an Application Program Interface (API)) is so concerned. This enables the Show Object (i.e., another API that is responsible for actually formatting and presenting the Enhanced Content to the client) to function without concern as to the origin of the Enhanced Content segment(s) to be presented. Thus, the abstracted Show Object is much like a car engine in that the engine doesn't care where or how it gets the fuel it needs, it is merely concerned with utilizing the fuel made available to it as efficiently as possible while maximizing the performance of the car.

Another advantage of the system is that it changes the nature of advertising. Since additional information can be now given, via the present invention, to consumers automatically and without large downloads. The system enables the advertising to be more interactive, responsive, and substantive. Such real-time responsiveness allows customers to make more informed and/or spontaneous choices. Now, the act of purchasing a product seen on television or listened to via radio or other sound system can be streamlined—the consumer can be given the choice of buying the product instantly using the two-way capabilities of the system. For example, the processes of the present invention enable an Enhanced Content provider to quickly establish a virtual store on whatever device the client is using. Preferably, the client device includes a Web browser, but a Web browser is not required to implement the present invention. Thus, all that is needed to establish such a virtual store, is the configuring of a Virtual Stage and then the pushing or pulling (for example, in FLASH) of those store elements needed (racks, clothes, cashiers, etc.) to/by an abstracted Receiver Object which, as directed by the Stage Manager, provides the Enhanced Content (for example, in a FLASH format) to an abstracted Show Object for presentation to the client.

In addition, users can take advantage of the two-way capabilities of the Internet to respond to polls, to send e-mail or to link to additional sites. For example, a viewer watching a television news program, through the system of the invention, can receive a stream of Web pages (i.e., Enhanced Content) which provide additional, specific information relating to the news content. Such information might also be received as a chat message (provided in any format), which the client device suitably processes via the Receiver Object API, the Show Object API and a Subscriber Object API (e.g., configured to process chat messages) and suitably presents, via the Virtual Stage, to the client.

Further, video programming and corresponding Enhanced Content (which may include static or dynamic Internet pages) can be viewed on a personal computer equipped with a television card and a Browser. The Virtual Stage approach, which utilizes a Show Object API and a Receiver Object API in the preferred configuration in conjunction with a Browser to create a Virtual Stage, enables any suitably configured client device to receive a Temporal Signal and Enhanced Content via a Virtual Stage, regardless of the device or the communications medium utilized.

By simplifying those systems and processes needed to marry the appeal of Temporal Signals (for example, a video signal) with the two-way data transfer capabilities of the Internet, a powerful new medium is created which allows producers of Temporal Signals and creators of Enhanced Content to combine their mediums and content without concern as to where, when or how such Enhanced Content will be received and/or processed by a client device. Such capabilities will allow advertisers to extend their brand identity and differentiate their program offerings to the millions of people who may not have a Web enabled television or a home personal computer but are equipped with a wireless Personal Data Assistant (PDA), telephone, pager, or similar device which can be configured to support a Virtual Stage. In addition to providing significant and immediate benefits to broadcasters and advertisers, the system will also present educational programmers with a way to more effectively use Internet resources in a classroom which is not bound by physical and/or temporal constraints.

Additionally, just as a Receiver Object API, a Show Object API, and other elements (for example, a Subscriber Object API) are utilized to create a Virtual Stage, an abstraction of a location providing Enhanced Content (i.e., a Virtual Site API) is also provided for by the extension of the client side processes to the server side. The Virtual Site API makes possible the creation of playlists (which identify those Enhanced Content segments that are to be synchronized with or are somehow related to a Temporal Signal). Further, the Virtual Site facilitates the creation of playlists without concern as to how, when, or where an Enhanced Content segment will be communicated to the client device. The Virtual Site allows programmers and other Enhanced Content creators to focus merely upon the creation of programs and related Enhanced Content. The Virtual Site also enables a producer to access Enhanced Content segments, regardless of the origin, and then reconfigure such segments into a format supported by a particular communications medium and/or client device. Thus, when a Virtual Site is utilized, two different classifications of personnel may be utilized to create and present Enhanced Content related to a Temporal Signal. These classifications are: programmers/content creators, who create the Enhanced Content segments based upon a Virtual Site; and producers, who control the Virtual Site such that the Enhanced Content, regardless of origin or format, is appropriately configured and transmitted to a client device over a given communications link.

For example, a programmer creates a playlist for a game show question and answer segment (i.e., the Enhanced Content segment) based upon an abstraction of a transmitting site, i.e., a Virtual Site. The game show segment is then provided to the producer who determines (in advance of the Temporal Signal or on a real-time basis) that client devices will/are request(ing) access to the Enhanced Content segment via the Internet, a direct cable modem link, and/or a wireless link and that the segment will be presented to the client via a PDA. Instead of having to create a playlist for each of the above types of communications links, the programmer can create one playlist of segments which are directed towards the Virtual Site. The segments are then converted by the producer, as necessary, into a format compatible with each type of communications link and/or device over which requests for the Enhanced Content segment are received.

Thus, the present invention provides abstractions of a Virtual Stage and/or a Virtual Site. The Virtual Stage enable clients to receive Enhanced Content segments, preferably via a Browser provided on their device, without experiencing lengthy downloads and initialization sequences. Similarly, the Virtual Site enables programmers and creators of Enhanced Content to create segments without concern as to the specific communications links or client devices utilized to receive the segments.

### BRIEF DESCRIPTION OF THE DRAWINGS

FIG. 1 is a diagram of a prior art system design showing the receipt and decoding of video signals at the subscriber location.

FIG. 2 is a diagram showing an alternative prior art system embodiment to achieve the integration of the Enhanced Content with the Temporal Signal (as represented by a video signal) by decoding a URI at a server site and then transmitting the URIs to the subscriber client devices via the Internet.

FIG. 3 is a flow diagram of the basic software design utilized in the prior art to provide Enhanced Content related to a Temporal Signal to a client devices.

FIG. 4 is a diagram showing another prior art system which provides for the direct transmission of URIs over the Internet to the client devices at a broadcaster's entered time without encoding the URIs into the VBI.

FIG. 5 is a diagram of another prior art system which utilizes a digital cable box as an element of a client device for presenting Enhanced Content related to a Temporal Signal.

FIG. 6 is a diagram of another prior art system which utilizes a digital television as an element of a client system for presenting Enhanced Content related to a Temporal Signal.

FIG. 7 is a diagram of a prior art distributed communications server embodiment for providing Enhanced Content related to a Temporal Signal to a client device.

FIG. 8 is a flow diagram illustrating the process by which a Virtual Stage and Enhanced Content is presented to a client via a client device for a preferred embodiment of the present invention.

### DETAILED DESCRIPTION

As discussed above, the present invention includes a system and process for providing Enhanced Content related to a Temporal Signal to a client device without requiring lengthy downloads and/or timely initialization sequences. The system and process may be implemented on any client device or system capable of receiving Enhanced Content related to a Temporal Signal. For purposes of illustration, such a system and process is described in relation to a system and process configured for communicating Enhanced Content related to a Temporal Signal as disclosed and discussed in the previously identified Hidary patents, the DCN application and also the FLASH application, the text of some of which are explicitly incorporated herein (for purposes of clarity) and otherwise incorporated by reference.

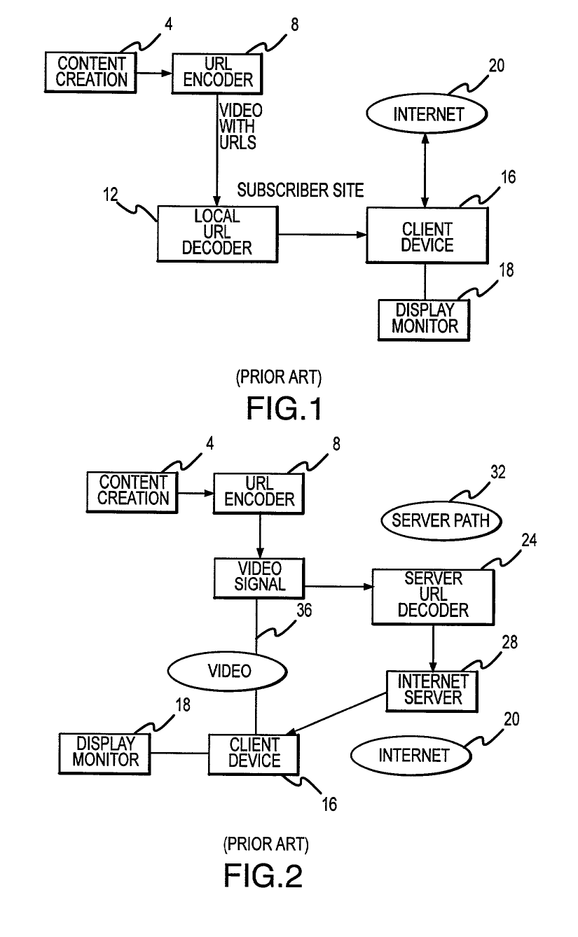

As discussed in the previously mentioned references, a system for combining the rich visual capabilities of video with the vast resources of the Internet is shown in FIG. 1. As shown, such a system is preferably a computer based system which receives a Temporal Signal (for example, a video program) along with embedded URIs, which direct the client's device 16 (for example, a personal computer or other device capable of receiving Enhanced Content) to address locations, or Web sites, on the Internet 20 to retrieve at least one Web page associated with the Enhanced Content that relates to the Temporal Signal. The particular Temporal Signal may include, but is not limited to, audio, video, textual, graphic, and virtual segments, and may be delivered in any format, for example, analog, digital or digitally compressed formats (e.g., MPEG 2, MPEG 4 and MPEG 7) via any transmission means, including satellite, cable, wire, television broadcast, wireless network, or via the Web.

The Temporal Signal is preferably created at a centralized location (i.e., content creation 4 as shown in FIG. 1) for distribution to clients at any location where a client device 16 can receive a Temporal Signal (for example, in their homes, car or via wireless device). Creation of the Temporal Signal is accomplished according to any conventional means known in the art. After a Temporal Signal is created, URIs identifying Enhanced Content related to the Temporal Signal are embedded into the Vertical Blank Interval (VBI) of the video programming segment of the Temporal Signal by, for example, the URI encoder 8, as shown in FIG. 1. In this embodiment, the URIs are encoded onto eight fields of line 21 of the VBI. Line 21 is the line associated with close captioning, among other things. However, the URIs could also be embedded in other fields of the VBI, in the horizontal portion of the video, as part of the audio channel, in any sub-carrier to the video or, if digital, in one of the data fields.

Although FIG. 1 shows the video with URIs over the same transmission line, the URIs can be sent to a client device 16 independently of the Temporal Signal (and independent of the video programming segments) on a separate data channel. In this embodiment, the URIs can be forwarded to the remote sites either prior to initiation or during the program. Preferably, the URIs have associated time stamps which indicate to the subscriber stations when, during the Temporal Signal, to present the particular Enhanced Content addressed or associated with the Temporal Signal to the client device. Alternatively, client can select when to call the particular Enhanced Content for presentation with the Temporal Signal (for example, a presentation of a Web page, a FLASH page, or any other segment at a specific time point during a video program).

Once the Temporal Signal is created, it can be transmitted to client devices 16 over any transmission means including broadcast, cable, satellite, wireless, or Internet. Further, the Temporal Signal may reside on video servers, be presented live, or even contain, in whole or in part, pre-recorded signals, for example, those provided on a VHS or Beta tape, DVD, CD, memory stick, or other medium.

Preferably, each receiver station comprises any Intel x86 machine (preferably a 486 processor, Pentium processor, etc.), an Apple Computer, UNIX or any other type of generic purpose workstation or standard computer workstation. Those skilled in the art appreciate that as the miniaturization of electronic computing devices (specifically computer workstations) continues, such devices may become available in various configurations of size, shape and capabilities. Thus, the client devices 16 capable of utilizing the present invention are not to be construed as being limited to any specific embodiment of a computing device. As such, any device capable of presenting the Enhanced Content may be utilized to provide the features and functions of the present invention including, but not limited to, a personal computer, a computer workstation, a wireless personal computer, a PDA, a wireless communications device, a main frame computer, and any other device capable of receiving Enhanced Content and/or a Temporal Signal.

In the embodiment shown in FIG. 1, the client device 16 is preferably connected to either a cable and/or broadcast television connection or to a local VCR or other video source. At each client site, the client device 16 preferably receives the Temporal Signal by a cable connection. The video/audio program can then be processed for display on a video screen using known in the art systems. For example, in a personal computer embodiment, any conventional PC card capable of displaying NTSC signals on a computer monitor, such as a WinTV card may be used. In addition to the cable connection, however, an Internet 20 connection is also provided concurrently with the cable connection.

The Internet 20 connection can be via any systems, devices, methods, or mediums capable of establishing communications between a client device and an Internet server including, but not limited to, high-speed lines, radio frequency signals conventional modems or by way of a two-way cable carrying the video or audio programming. The client device 16 has Internet access via any of the current ASCII software mechanisms. In one embodiment, at each subscriber home, an associated local URI decoder 12 receives the cable video television program, as shown in FIG. 1. The local URI decoder 12 extracts the URIs, preferably embedded in the VBI of a video portion of the Temporal Signal, with the use of any conventional VBI decoder device. The URI decoder 12 may be either a stand-alone unit or a card which is implemented by the client device 16.

In another embodiment shown in FIG. 2, the URIs are encoded into the video portion of a Temporal Signal in the same manner as described above. Again, the URIs are preferably encoded onto eight fields of line 21 of the VBI, but may also be sent independently of the video. In this embodiment, the URI decoder 24 is located at the server site, as opposed to the client location. When the decoder 24 receives the video program signal, it strips out the URI codes on line 21 of the VBI and delivers these codes independently to an Internet server 28. The URI code is then subsequently delivered over the Internet 20 to the client device 16. Simultaneously, the Temporal Signal is broadcast over conventional broadcast or cable transmission means 36 to the client's device 16.

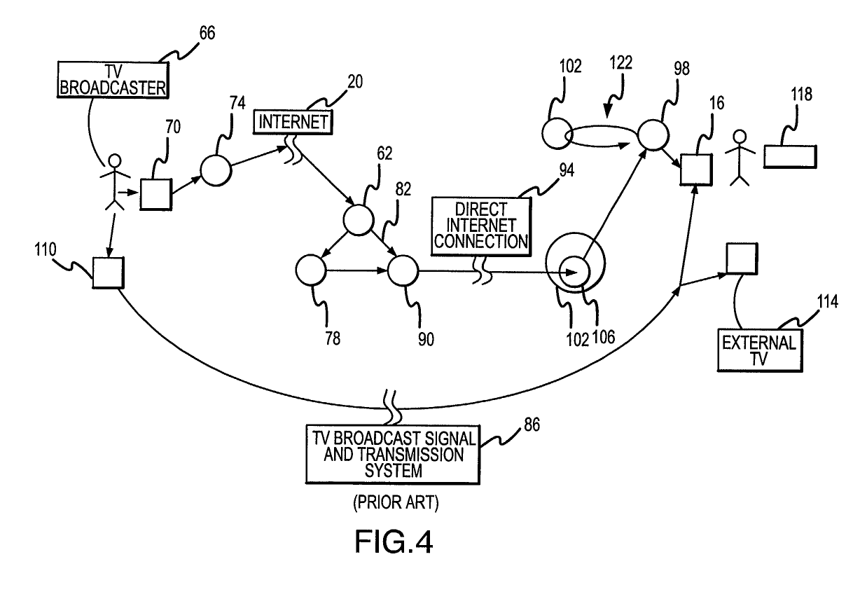

Another embodiment of a compatible system is shown in FIG. 4. This system does not depend on, or even use, the VBI. In this embodiment, the system provides an online service over the Internet 20. This service is in the form of an Internet Web site 62 that provides a client-interface to a database 78 and to one or more associated data servers 90. Member-accounts are provided to TV broadcasters 66 who sign up to use the system in conjunction with their broadcasts. Each member broadcaster will enter the service at their computer 70 through Browser software 74 using their member account by entering various identification and password information. Once within their account, the member will be provided with a graphical user interface for pre-scheduling Enhanced Content (which may include URIs) for transmission to clients 118 over a direct Internet connection 94 at particular times of the day. The same client interface, or a variation on it, can be used by broadcasters for live transmission 82 of URIs (or Enhanced Content) to clients at the same time as a broadcast 86.

Other embodiments of a compatible system may be configured that do not depend on, or even use, the VBI, or the Internet for establishing a connection between the client device 16 and the location providing the Enhanced Content. For example, one such system may directly provide Enhanced Content, for example, via a wireless network, over a telephone network, a satellite network, or even a local area network. Thus, it is to be appreciated that the present invention is not limited to a system which utilizes a television video signal, VBIs, URIs, the Internet or any other device or system to provide Enhanced Content related to a Temporal Signal. Further, the present invention may be configured such that the URIs (or other triggers) are embedded in static media (for example, a CDROM). In such an embodiment, the static media, versus a propagated programming signal, pushes the triggers/URIs which are then utilized in accordance with the systems and processes for creating a Virtual Stage and presenting Enhanced Content on a Virtual Stage, as discussed in greater herein.

It is further appreciated that various embodiments can also be used which enable personalization in the form of unique series of Enhanced Content specific to each client's unique profile, which are directly sent over a network (for example, the Internet) to each client's device. This can be achieved from the broadcaster to each individual client, or to particular collections of clients. To accomplish personalization, the service may send a different stream of URIs or even a different stream of Enhanced Content to each client's device. The stream of Enhanced Content (or URIs identifying locations for such content) sent would depend on a client profile stored in the database or at the client device 16. As is well known in the art, a client profile may be built on demand or over time for each client based on criteria such as the location of the client, choices the client makes while receiving a Temporal Signal and/or Enhanced Content, or choices the broadcaster 66 makes during a broadcast 86, or automatic choices made by an algorithm (such as a filter) residing on the service 62. Personalization enables each client to receive Enhanced Content and/or URIs which are uniquely relevant to their interests, demographics, history, or behavior in the system.

Once the URIs have reached the client device 16, system operation is similar for all of the embodiments diagramed in FIGS. 1, 2, and 4. In the preferred embodiment, a Browser 98 is installed on the client device 16. The Browser 98 allows the client device 16 to retrieve the Web pages 102 or other Enhanced Content, since it is platform independent, and thus, enables efficient and flexible transfer of programs, images, etc., over the Internet or other networks to the client device. Therefore, it is to be appreciated that the process works in and/or with systems that push URIs to a client device and those that do not (i.e., a system wherein the first operation requires the client device to establish a communications link with a location providing Virtual Stage creation elements). In short, the system is capable of presenting Enhanced Content on a client device regardless of the particular systems or methods utilized to create a synchronization between the Enhanced Content and the Temporal Signal. As such, the system is independent of the communications medium, the format, the source, or any other element of the Enhanced Content and/or the Temporal Signal. However, in the preferred embodiment, the Browser is the preferred platform upon which a Virtual Stage is created, as is explained in greater detail below.

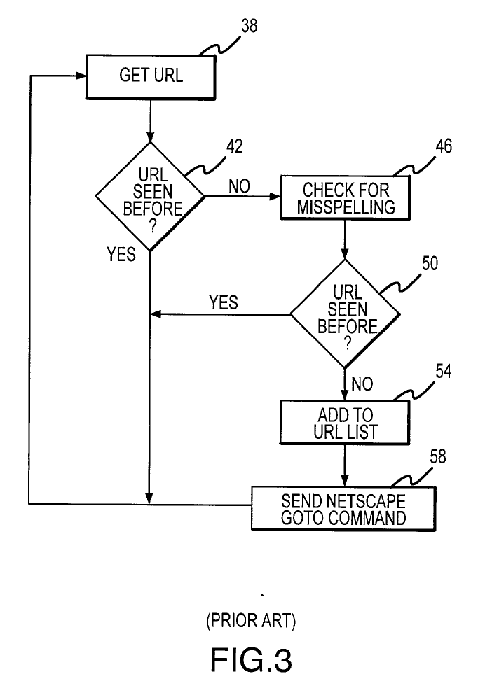

Further, in those embodiments in which a URI is embedded in a VBI or other segment of the Temporal Signal, specialized software is provided in addition to the Browser which enables the client device 16 to extract the URIs from the Temporal Signal. The specialized software acts as an interface between the video programming and the various Internet functions provided by the system. The specialized software retrieves URIs from the video program (embodiment of FIG. 1) or directly from the Internet connection (embodiments of FIGS. 2 and 4), interprets these URIs and directs the Browser 98 to retrieve the particular relevant Web pages 102. In certain embodiments, wherein multiple URIs are sent in conjunction with the Temporal Signal, the specialized software also synchronizes the retrieved Web pages to the Temporal Signal for presentation to the client via the client's device 16, as shown in FIGS. 3 and 4 and explained in more detail below.

Further, one embodiment of the specialized software also has the capability to detect identical URIs sent directly after one another which causes the Browser not to fetch URIs in these particular cases. As shown in FIG. 3, once the URI code is received at the client device 16 (operation 38), the specialized software interprets the URI and determines whether the particular URI has been received previously (operation 42). If it has already been received, the next received URI is interpreted for determination of prior receipt. If the particular URI has not been previously detected, the software checks for misspellings and any other errors. If errors exist, the specialized software corrects the particular errors (operation 46). Once again, it is determined whether the URI has been previously detected. If it has, the next URI is accessed (operation 38). If the URI has not been detected, the specific URI is added to the URI list (operation 54). The specific URI is then sent to the Browser 98, which is preferably a JAVA enabled Browser. Upon receipt of the URI, the Browser 98 accesses the Web site address 122 (FIG. 4) indicated by the URI and retrieves the cited Web page 102 via the Internet or other network connection (operation 58). At this point, i.e., when the Browser establishes a connection with a Site providing Enhanced Content for a Virtual Stage, the present invention suitably establishes a Virtual Stage on the client device 16 utilizing the process discussed herein below.

Regardless of whether the URIs, addressing a Web page providing the Enhanced Content related to a Temporal Signal, are accessed after extraction from a VBI or otherwise obtained, for the preferred embodiment, the process suitably entails establishing a Virtual Stage on the client device's Browser before any Enhanced Content is received and presented to the client. As discussed previously, the Virtual Stage provides a platform (a Stage) upon which Enhanced Content may be presented regardless of the source of the Enhanced Content, the communications link utilized, the format of the Enhanced Content, the type of Temporal Signal, and the type of client device.

While the Virtual Stage is discussed in the context of being created on, and/or via a Browser, it is to be appreciated that such Virtual Stage may also be created on other platforms or applications (either generic or specialized) as desired. However, a Browser is the preferred platform upon which the Virtual Stage is built, because of the widespread availability of Browsers and the non-device and/or signal specific characteristics of such Browsers.

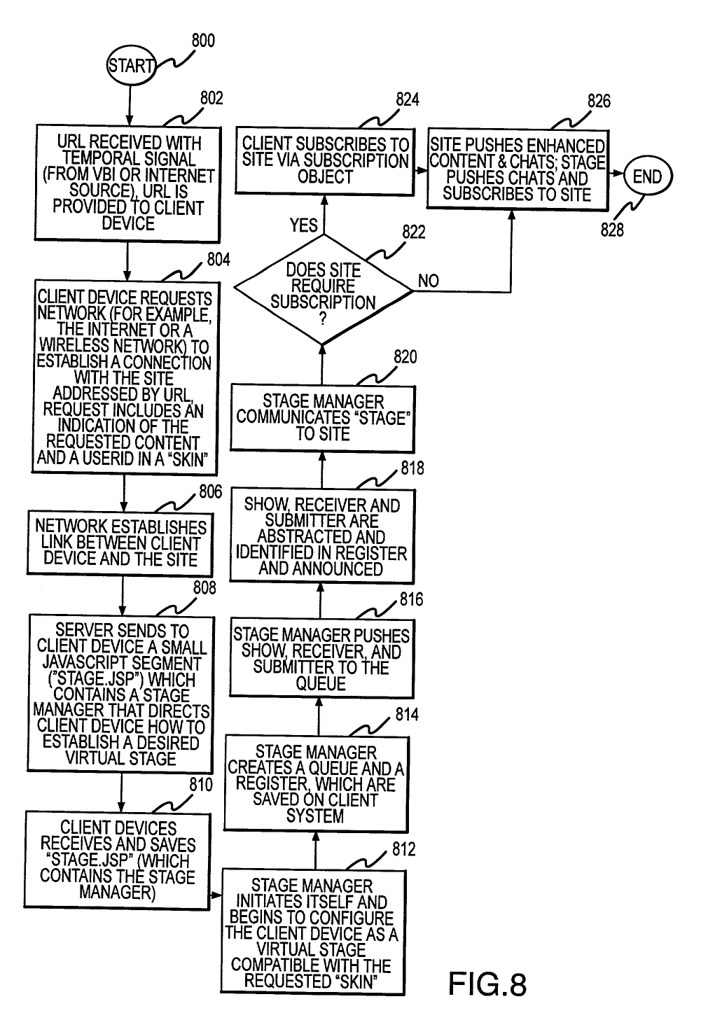

The process by which a Virtual Stage is established on the client's Browser is illustrated in FIG. 8. As shown, the process begins upon the reception by the client device 16 of a URI, or similar address, identifying a provider of Enhanced Content related to a Temporal Signal. Preferably, the extraction of the URI, as necessary, from a VBI or other segment of a Temporal Signal has already occurred and has been provided to the Browser for establishing a connection with the Site addressed by the URI (operation 802). The Browser then suitably requests a network to establish a communications link with an online information provider site identified by the URI or other address (hereinafter, the “Site”). Upon establishing a link with the Site, the Browser (either automatically or in response to a query issued by the Site) communicates a userid and an indication of either the URI extracted from the site, the Temporal Signal to which the URI relates, and/or any other incidence of Enhanced Content of which the client device desires to receive (hereafter, a “Skin”) (Operation 804). As such, the Skin preferably communicates sufficient information which enables the Site to determine: (1) which Enhanced Content the client desires to receive, and (2) the identity of the client device (and/or the client).

It is to be appreciated, that the Browser may be configured to send the Skin when initially requesting the establishment of a communications link with the Site or upon reception of a query from the Site. Further, a userid is preferably communicated by the Browser to the Site thereby providing an identification of a client to a provider of Enhanced Content. Such identification is desirable, for example, in an educational environment to identify individual students and teachers (as discussed in greater below), to facilitate user profiling and the targeting of content to such user profiles, and for any purposes which utilize, rely or depend upon a userid. Additionally, while the Skin preferably contains two elements, additional elements may also be provided, for example, an indication of the network or other communications system utilized to reach the Site, the type of client device being used by the client, the location of the client device, and/or the processing capabilities of the client device.

At this point, a communications link is established between the client device and the Site (Operation 806). The communications link may be configured from any single or combination of system, links, devices, paths, or mediums, including, for example, the Internet, intranets, extranet, Ethernet, dial-up network, regional network, wireless networks, cable links, satellite links, wireless links, broadcast networks, hubs, routers, transmitters, and receivers. As discussed previously, the Virtual Stage is device, system, communications link, and content non-specific and preferably may be utilized on any and all devices.

Once the communications link is established between the Site and the client device, the process of creating the Virtual Stage continues with the Site sending a java script program (for example, under a filename such as “stagejsp”) to the client device. The java script preferably contains those elements necessary to initialize the Virtual Stage and a Stage Manager (Operation 808), which “oversees” the creation and use of the Virtual Stage.

More specifically, upon receipt of the “stagejsp” (hereinafter, the “Routine”), the client device automatically initializes the Routine. However, as desired, the Routine may also be configured to initialize at a later time and/or upon receipt of a command from the client. Once initiated, the Routine effectively detects the production (i.e., the presentation of the Enhanced Content related to a Temporal Signal) specific platform utilized by the client device. For example, in a first presentation, a Flash platform may be utilized and, in a second presentation, a textual platform may be utilized by the same client device. The Routine also detects those production specific settings (for example, the identification of the Show) and requests additional pages (which may include additional program codes) from the server based upon the detected information. Basically, the Routine determines which implementation (i.e., which API) of the Show Object, Receiver Object, Subscriber Object, and any other Object (for example, a chat filter, and the “splash” screen presented on the client device while the Virtual Stage is configured) are needed to present the Enhanced Content. The Routine then requests and receives those APIs and other Objects and elements needed from the server (if it does not already possess them).

The Show Object, Receiver Object, and Subscriber Object APIs may communicate with each other via structural function calls, object messages, an abstract event model, or other invocation pattern, all of which are equivalent for purposes of the present invention. Further, the Show, Receiver Object and Subscriber Object received from the Site are, in their most basic form, expectations on the availability of certain functions and behaviors. For each specified function/behavior, the Virtual Stage actually implements at least one on the client device. Thus, when the Virtual Stage is configured, at least one Show Object implementation and at least one Receiver Object implementation (in addition to other implementations) is provided. Further, each implementation of an Object (for example, a Show Objector a Receiver Object) is independent of the implementation of any other Object. Thus, a mix and match relationship is created by the Virtual Stage based upon the platform (i.e., is it an Internet Explorer Browser or a Netscape Browser), the client device (i.e., a personal computer versus a PDA), and the Enhanced Content presentation. Such mixing and matching is limited only by those implementations viable on a given platform, client device, and configuration of the presentation, as commonly determined by the producer of such presentation. Such a configuration is analogous to a video signal coming into a home via a cable box, routed through a VCR and then to a television. The video signal is the same regardless of the cable box receiving it. The cable box decodes the signal regardless of what, if any, VCR is connected to it, and the VCR will record and play back the signal regardless of whether a television is attached and/or turned on. Each element performs its respective job regardless of the precise configuration of the other element. However, the signal passing from one device to another ultimately must be compatible with both devices, and thus some non-discriminatory dependencies exist between the devices, provided they fall within a given set of parameters.

For the Virtual Stage, the Temporal Signal embeds the URI regardless of where they point (i.e., which data file is addressed by the URI) or how they are decoded. The Receiver Object (whether in Java, javascript, ActiveX, or another format) decodes the URI and calls the API of the Show Object associated with the type of Enhanced Content to be presented. Whichever Show Object is instantiated renders the URIs, including the chat, rooms, URIs, and actions, as appropriate for the implementation. As such, a similar set of dependencies are created between the various Objects (for example, the Show Object and the Receiver Object), while similar levels of non-discrimination are created between the Objects.

Further, the “stagejsp” program elements and the Stage Manager are saved in the client device or elsewhere in an appropriate storage location, for example, RAM, EPROM, a hard disc drive, a memory stick, or a memory card (Operation 810). At this point, or at a later point (as desired by the specific implementation of the Virtual Stage), the client device directs the Stage Manager to initiate the creation of the Virtual Stage (Operation 812).

As mentioned previously, the Virtual Stage includes at least a Show Object and a Receiver Object. However, before those Objects can be created a “floor” and an organizational framework for the Virtual Stage is created. Thus, at this point of the initialization routine, the Stage Manager begins to create those elements necessary to configure the client device to operate as a Virtual Stage. As is appreciated by those skilled in the art, such elements are generally stored in memory locations as data variables and abstractions of objects commonly found in a stage. For example, a brick and mortar stage commonly contains at least one stage or presentation area on which the theatrical show is actually presented to the viewing audience and also includes hidden areas where the technical assistance necessary to “put-on” the show is located. Such hidden areas often include stage hands who, for example, call actors for appearances on the stage, and otherwise control the lighting, audio, props, the interface with the audience (when available), and various other aspects of the presentation. Directing the theatrical presentation is often a stage manager who oversees all of the functions of both the presentation itself and the stage hands.

For the Virtual Stage, similar elements are created, including a Show Object (i.e., the publicly viewable presentation platform) and a Control Area (i.e., the hidden areas from which the stage hands control the presentation). More specifically, the Control Area contains and controls those necessary interfaces between the Show Object and the external environment (i.e., everywhere except for the Show Object area presented on the client device).

However, before the Virtual Stage can be created, the Stage Manager requires two Objects to first exist, a Queue and a Register. Both of these are preferably initially created by the Stage Manager (Operation 814). The Queue provides a listing of tasks to be completed by the Stage Manager in order to configure the client device for the presentation of the Enhanced Content on the Virtual Stage. The Queue is suitably utilized both during the configuration of the Virtual Stage and during the presentation of the Enhanced Content, as necessary.

Often tasks on a queue (as used in the computer sense) are completed in the order in which they are entered into the queue. However, the Queue is preferably configured to emulate and utilize well known threading techniques from other programming languages including “C” and Java. Examples of such threading techniques include, but are not limited to, wait and notify blocking, mutex locks, semaphores, and synchronization. As such, the Queue preferably contains two fields: a pre-condition field (true or false), and a firing field (i.e., the particular action to be initiated when the pre-condition is true).

For the Virtual Stage, the Queue preferably utilizes at least one threading technique to determine when to cycle through its listing and trigger applicable events, tasks, and/or Objects. As is commonly appreciated, the wait and notify technique is more efficient than using a polling technique, as such the Virtual Stage preferably utilizes a wait and notify scheme. However, utilizing this and similar techniques creates a dependency for the Queue upon other Objects (for example, the Register) to notify the Queue of state changes and, thus, for specific applications, other threading techniques may be utilized.

The other element the Stage Manager initially creates is the Register. The Register is basically a table identifying the existence of an element and how it can be reached. In the brick and mortar stage, a register might include a listing of stage locations (which may be hidden or in view) and how to get to such locations (for example, a stage location situated on a raised lighting assembly might include directions on how to find the assembly). In the Virtual Stage, the Register preferably contains two columns, an Object column and a Key column. The Object column identifies a particular Object and the Key column identifies where the particular Object is located (for example, a RAM pointer or java script pointer which identifies where the Object can be found in a memory or storage device). The Register enables the various Objects of the Virtual Stage to create dependencies to each other, such that when a first Object is referenced by a second Object, they may suitably locate each other.

Additionally, the Queue and the Register preferably work in conjunction to initialize the Virtual Stage. For example, when an Object is added to the Register, the Register suitably “announces” the Object and thereby signals the Queue to survey those tasks on its listing and perform any task which was waiting, for example, upon the “announcement” of the given Object.

At this point in the Routine, the Register preferably contains only one row containing a reference to the Stage Manager itself and where the Stage Manager is located.

Once the Queue and the Register have been created, the initialization process, which is suitably customized on a per-production basis continues with the Stage Manager calling a push method from the initialization routine stored in the memory location identified in the Register as the location of the Stage Manager. Or, in other words, the Stage Manager instructs itself to perform a specific task (a push method) which is co-located with itself. The push routine directs the Stage Manager to create a framework for the stage and the hidden Control Area off the stage. Additionally, the push routine loads into the Queue an instantiation (a time specific representation) of a Show, a Receiver Object and, optionally, a Subscriber. As other elements are needed for a specific Virtual Stage implementation, such elements may also be pushed into the Queue at this time or a later time.

In the Virtual Stage, the Show Object provides instructions to the client device on how to utilize its presentation space (i.e., the stage platform) to present the Enhanced Content. To provide such instructions, as mentioned previously, the Show Object is preferably configured as an API which knows how to present to the client, via the Browser, pushes, chats, and rooms. However, before such elements may be presented on the Show Object to the client, the Stage Manager must first subdivide the stage platform into an appropriate number and configuration of sectors, or frames, as needed (if any).

In a brick and mortar stage, for example, risers are situated in various portions and locations, such as “stage left” or “stage right” to divide the main stage into segments. Additionally, the brick and mortar stage might also contain initially only one frame (i.e., a stage with no risers, props and/or furniture), upon which additional elements are added or subtracted as needed. Additionally, it is appreciated in such an environment, that sub-frames are dependent upon the main frames upon which they are built. For example, a riser can not be extended until the main stage exists.

Similarly, for the Virtual Stage, a sub-frame can not exist until the frames upon which it depends exist. As such, a hierarchical relationship exists between the various frames and sub-frames which may exist for a Show. Often such a relationship is a cascading relationship. For example, suppose a frame definition for Virtual Stage existed as follows:

element “A” is identified as “A.html” and is situated in the top (the root) of the tree and is always available;

element “B” is identified as “B.html” and located in section “X” of element “A”;

element “C” is identified as “C.html” and located in section “Y” of element “A”; and

element “D” is identified as “D.html” and located in section “Z” of element “C”. When a push targeted at section “W” of element “D” arrives, the following cascade of pushes occurs:

“D” is not available yet, so “D.html” is pushed into “Z” of element “C”;

since “C” is not yet available, “C.html” is pushed in to “Y” of element “A”;

since “A” is not yet available, “A.html” is pushed into top.

The result being that none of the pushes occur because none of their respective pre-conditions have been satisfied. However, when “A.html” completes, it announces itself to the Queue, firing the push of “C.html”. When “C.html” completes, it announces itself to the Queue firing the push of “D.html”. When “D.html” completes, it announces itself to the Queue firing the push of “W” into “D”—the original request, which is then completed. All of these actions commonly occur in a client imperceptible moment. Thus, dependencies and cross-dependencies may exist between the various Objects which constitute the Virtual Stage.

Additionally, utilizing this configuration, the system correctly handles competition for the same resources (or stage locations) by utilizing a last in time, last in right system, wherein the last Object to announce itself, unannounces any other Object competing for the same resources. In this manner, the Virtual Stage does not have to concern itself with deleting unneeded Objects or elements as their existence is unannounced once a competing Object or element acquires a given resource. However, in alternative embodiments, an “unannounced” system or approach may also be utilized.

The Virtual Stage also enables the framing to be defined initially and then may vary as the presentation proceeds. To accomplish such framing, the client device preferably divides its presentation space (e.g., the video screen's area) into a given number of frames and sub-frames. When an HTML platform is to be utilized, the client device may, for example, create three frames, one frame in which chat messages occur, a frame in which advertisements are presented, and a frame in which on-line content is presented. Similarly, when a FLASH platform is to be utilized, the client device may create only one frame on which the FLASH segments are suitably overlaid. The number of frames may increase or decrease. For example, a client may decide that they do not wish to receive chat content. In such an event, the Stage Manager may suitably reconfigure the frames, or may leave the chat frame (“room”) open for the client to later re-enter.

For the preferred embodiment, a single frame stage is preferably utilized and upon which FLASH presentations are suitably overlaid, as discussed in the FLASH application. An instantiation of such a Show Object on a single main frame stage might include a push as follows: “stage/show/flash/ie.main”. This push directs the client device to establish on an Internet Explorer (IE) configured Browser a stage which includes a main frame on which a Show Object composed of Flash elements is to be presented. Other instantiations of a Show Object frame push might include, for example, “stage/show/html/ie.main”, in which Hyper Text Markup Language (HTML) based Enhanced Content is presented on the main portion an IE Browser.

Similarly, instantiations of a Show Object may be utilized for other Enhanced Content formats including: FLASH content (“stage/show/flash/ie.main”), XML content (“stage/show/xml/ie.main”), DHTML, Java and other formats, and/or for other types of Browsers (such as a Netscape® Browser or AOL® Browser) or client devices. It is to be appreciated that as the presentation area of a client device is dissected, additional instantiations of a Show Object sub-element may also be provided to the Queue.

Regardless of the number of frames and sub-frames created on the Virtual Stage by the Stage Manager at initialization or later in the presentation, once a frame is created, each frame ultimately is matched with a Show Object element, an instantiation of which is suitably listed in the Queue. The Show Object element is that element which identifies to a Receiver Object where it is located and how Enhanced Content is to be presented. A Show Object element may be configured for processing content, chats, and/or other types of Enhanced Content.

Further, as mentioned previously, after the announcement of an Object, the Queue suitably cycles through its listing searching for any Objects (actions, or other elements) to trigger, which depend upon the given announcement. For example, a Show Object action may require a sub-frame off a main frame to be provided on the Register and announced before the Show Object element on the Queue is triggered. That is, the sub-frame can not exist on the Register until the main frame exists. Likewise, the Show Object can not exist until both the main frame and the sub-frame exist on the Register. Thus, as the Queue completes its various configurations of Objects, such Objects are suitably identified in the Register.

Once a first Object is identified in the Register, any other Object requesting or depending upon the first Object may obtain a reference location from the Register (until the Object is unannounced). In short, the Register provides pointers to where other Objects are located such that mutual dependencies between Objects may be created, as dictated by the Stage Manager. Since mutual dependencies are created, as necessary, between various Objects utilized by the Virtual Stage, a single Object does not depend upon how a specific Object is implemented and instead merely depends upon the Object's functionality (for example, retrieving Enhanced Content from a site regardless of how accomplished).

For a brick and mortar stage, similar dependencies often exist. For example, an actor in a play depends upon a lighting technician (commonly located in a backstage, hidden area) to control the lighting of the stage to enhance the mood and environment in which the actor is trying to present. The actor generally is not concerned with how such lighting is generated and instead merely depends upon the lighting to accomplish the scene. However, when the function (the lighting) ceases to operate, for whatever reason, the actor can no longer perform the scene. Thus, dependencies exist between the actor and the stage hand that are based upon the functions performed by each and not on the specific details of how such functions are provided or implemented.

In addition to pushing the Show Object (i.e., how the presentation area of the client device is to be utilized), the Stage Manager also pushes a Receiver Object and (optionally) a Subscriber Object to the Queue. The Receiver Object and the Subscriber Object are similar to the lighting technician (stage hand) of the brick and mortar stage in that they provide hidden functions which are often crucial to the success of the presentation by the Show. Both the Receiver Object and the Subscriber Object are provided for in a hidden Control frame (i.e., a “backstage” area of the Virtual Stage that is not presented to the client) (Operation 818). As with the Show, which requires a frame to be constructed before the Show Object itself could be constructed, the Receiver Object and/or the Subscriber Object also require a Control Area to be Registered before they can be configured and instantiated by the Stage Manager into abstractions identified by the Register. Further, the Control area itself is preferably identified as a hidden frame on the Browser that is further broken into two hidden sub-frames, a receiver and a subscriber. The process of creating the Control Area mirrors that of creating the main frame and other sub-frames. However, unlike the main frame and its sub-frames, the Control Area is preferably never modified or deleted during a presentation as its existence is crucial to the success of the show, even though it is hidden. Deleting the Control Area is comparable to pulling the power on a brick and mortar theatrical presentation, in that the presentation (i.e., the show) would immediately grind to a halt.

Similarly, just as a brick and mortar show may be restarted after a power or other interruption, the Virtual Stage may also be restarted or continued (when nonvolatile memory is utilized to contain the various Objects utilized by the Virtual Stage). More specifically, since the Stage Manager itself is identified in the Register, the Show Object may be restarted by the Stage Manager re-configuring and re-instantiating the Control Area, the Receiver Object, the Show Object, and the Subscriber, and other elements, as necessary, in the Queue and the Register.

Once the Control Area is appropriately configured, the process of creating a Virtual Stage preferably continues with creating the Receiver Object. The Receiver Object is preferably the Object which creates and maintains a down channel with the Site (which may or may not be a Virtual Site). More specifically, the Receiver Object identifies itself as being that Object which will handle pushes, chats, rooms, and subscription announcements sent by the Site to the client device. Pushes, chats and rooms are herein described in abstract terms. The Receiver Object is preferably configurable such that it may receive pushes, chat, etc. regardless of their format (i.e., TCP/IP, UDP, etc.). For example, “hypervbi.html” might be one instantiation of a Receiver Object which knows how to receive Enhanced Content provided in a VBI. Similarly, “hyperweb.html” might be an instantiation of a Receiver Object which knows how to receive Enhanced Content provided over a Web connection. Based upon the configuration of the client device and/or the configuration of the Site (or the Virtual Site), the Stage Manager appropriately configures a Receiver Object that is compatible with the Site. As mentioned previously, the configuration of the Receiver Object, the Subscriber, and other elements is determined at the time of initializing the Routine.

The Receiver Object also identifies itself as being the Object which will call those routines provided in the Stage Manager and the Enhanced Content provided by the server to configure the client device to receive pushes. These pushes may be provided via various communications links and in various formats including, for example, over an Internet connection, a television broadcast connection, or a wireless connection. In this regard, the Receiver Object mirrors the Show Object in that the Receiver Object knows how to receive the pushes which are then rendered and presented to the client by the know-how of the Show. Since the Receiver Object and the Show Object are abstractions and APIs (as discussed previously), it is to be appreciated that they may be implemented on any device, utilizing any configuration. Thus, it is to be appreciated that the configuration of the Receiver Object vis-a-vis the Site, may occur at the Receiver Object, the Site and/or somewhere in-between (for example, a network hub).

The Subscriber Object is the other Object utilized to control the basic operation of the Virtual Stage. The Subscriber Object basically is an abstraction of a device which knows how to send chats and subscribes from the client device to the Site. As provided for the Receiver Object and the Show, the Subscriber Object is also identified in the Register to enable the Show Object to know where the element capable of sending subscribes and chats is located. The Subscriber Object also accesses those elements provided in the Stage Manager and/or the client device to make possible such chats and subscribes.

Up to this point, the Stage Manager has merely told the client device how to present information received from the Receiver Object, how to establish a connection with the provider of the Enhanced Content to be presented to the client via the Show, and how to subscribe to chat rooms and send, receive and present chat messages. However, while the preferred method includes an abstraction of only a Show, a Receiver Object and a Subscriber, it is to be appreciated that various other abstractions of Objects may be specified by the Routine and implemented by the Stage Manager. For example, an alternative embodiment of a Stage Manager may abstract two Receiver Objects, one for receiving Internet based content and one for receiving wireless content, both of which might be suitably presented on a single Show. Regardless of the number and/or type of abstracted Objects utilized, the present invention is preferably configured with, as a minimum, a Show Object and a Receiver Object. Further, the foregoing actions occur in today's processors so fast, that a client device is generally configured and ready to receive Enhanced Content without incurring any human perceptible delay.

Once the Show Object and the Receiver Object have been configured and identified in the Register (i.e., announced to the Stage Manager and the Queue), the process continues with the Stage Manager communicating a Stage (which includes an identification of the Receiver Object and the Show) to the Site (Operation 820). The Stage contains an identification that the Virtual Stage that is ready to receive the Enhanced Content. In the brick and mortar example, the communication of the existence of the Virtual Stage corresponds to a curtain call, wherein the actors and others (i.e., the Site) are informed that it is show time. Shortly thereafter, the various elements of the show (i.e., the Enhanced Content) are then presented to the viewing audience (i.e., the client). Importantly, the Stage and the Receiver Object are basically oblivious to the source of the Enhanced Content as they are mere abstractions, which are capable of receiving the Enhanced Content.

As such, the preferred embodiment of the process enables one to provide code for configuring the client device at either the server Site or the client device. The present invention facilitates the removal, to the server, of many of the device configuration actions thereby reducing the amount of memory, downloads, and routines needed to be used and/or executed by the client device to configure a Virtual Stage. However, it is to be appreciated that placing the device configuration codes on the Site results in less scalability, whereas placing the device configuration codes on the client device increases memory utilization. Thus, a trade-off exists between the higher scalability and the amount of memory needed on a client device to provide a given level of scalability.

Once the Stage is announced to the Site, the Site may then commence sending the desired Enhanced Content. However, often many Sites require a client to subscribe to the Site. The Subscriber object handles requests for subscriptions, which are suitably received by the Receiver Object, passed to the Show Object for presentation to the client, and then to the Subscriber Object (which may automatically generate or be manually configured to generate the subscription) and then send the subscription to the Site (Steps 822 and 824).

At this point, the client device is configured and ready to receive Enhanced Content that may or may not relate to a specific Temporal Signal. The Receiver Object receives the Enhanced Content pushes and provides such pushes to the Show Object for presentation to the client via, for example, a Browser. These pushes may come in any format including, but not limited to, URIs, content pushes, frame set pushes (which reconfigure the framework for the presentation area of the Browser), functional pushes (which often include both commands and data), and RAID pushes (as discussed in the above referenced FLASH application). Since these various types of pushes provide varying levels of commands and content, the Stage Manager is preferably configured to process functional pushes and RAID pushes, while the Show Object handles frame pushes and content pushes. Further, such pushes are carefully and precisely determined when pertaining to the hidden control area, the Receiver Object and/or the Subscribe Object, as a mis-configuration of such Objects/pushes may wreck havoc with the client devices' ability to receive and process Enhanced Content.

Thus, the Virtual Stage is preferably implemented on a Browser and is not implemented as a stand-alone application. However, the Virtual Stage may be implemented as a stand-alone application, as desired, with appropriate trade-offs in the necessary java script or Java applet or similar files to be downloaded and stored on the client device. In another embodiment, the Virtual Stage suitably reduces the need for large downloads and time consuming initialization routines and thereby enables the Enhanced Content to be quickly presented to a client via virtually any compatible device by providing such capabilities at the Site (or the Virtual Site).

Further, since the client device utilizes an abstraction of a Receiver Object in order to establish a communications link with a Site and receive Enhanced Content, it is to be appreciated that such abstractions may also occur at the Site itself. For example, a Site may be abstracted such that a single playlist for an Enhanced Content presentation may be generated, which is then abstracted by the Site, as necessary, into the appropriate data formats requested by the Receiver Object. Thus, a producer of Enhanced Content is capable of producing a single rendering of a playlist which may be communicated to various client devices over various implementations of a Site including, for example, an Internet site, a wireless site, an intranet site, and a broadcast site.

Additionally, it is anticipated, for example, that a television game show program presenting Enhanced Content to a multitude of clients may frequently encounter sudden bursts of responses (subscribes or chats) from multitudes of clients attempting to answer a game show question. Current server systems are extremely inefficient and often incapable of processing such sudden and dramatic subscribes because they often are configured to process a transaction completely before returning to a given process and then format the return values with the result. In contrast, a Site implementing the present invention preferably utilizes a Capture module, which is preferably located at the Site (or an independent location designated for receiving client subscribes). The Capture module provides an upstream data capture module which does not provide an immediate return value. Instead, the Capture module returns to the client before a transaction is completed. The Capture module schedules each client's subscribe/response for processing. Thus, the Capture module enables a Client to send up various pieces of information without delay. Further, the upstream interaction occurs on a queue hidden frame such that multiple upstream requests can be pending at any time and from multiple clients. This configuration allows the Show Object to continue processing Enhanced Content segments even if the upstream channel is blocked or unavailable for an extended period of time.

An exemplary implementation of the Virtual Stage can best be understood with reference to an example. A client can begin watching a musical video featuring a new band. As the video is received by the client device 16, URIs are either being received with the video signal or are being received directly via the Internet 20 or another data channel, and are being interpreted by the specialized software 106. Upon the first instance of receiving an indication that Enhanced Content is available, the Browser 98 retrieves a particular Web page 102 from an Internet 20 Web site that is identified manually or automatically. Upon establishing a connection with the Web site, the Browser receives the “stagejsp” program and begins installing the Virtual Stage.

Once the Virtual Stage has been established and its existence notified to a Site providing the Enhanced Content, the client device 16 may then begin receiving Enhanced Content, regardless of the source of such content. In a frame based example, such Enhanced Content is provided via HTML based Web pages which are suitably displayed on the video screen in a pre-determined frame format, at particular times. In the preferred Flash implementation, the Enhanced Content is presented as overlays to a master movie. Thus, for example, while the viewer is watching the music video, biographical information on the band can also be displayed adjacent to the video window, or in Flash, as an overlay on a full frame or partial frame window. The Enhanced Content could also include an upcoming concert schedule, or even audio clips of the band's music may be downloaded from the Internet.

As another example, a client could be watching a program relating to financial news. While the narrator is shown discussing high tech stocks, Enhanced Content corresponding to detailed financial performance information on high tech stocks, environment and characteristics can be displayed with the video on the Virtual Stage. Such Enhanced Content can be presented regardless of the source of the information or the type of device utilized by the client. However, preferably a Browser or application program is utilized on the client device to control the presentation space. If the personalization features are included, Enhanced Content associated with a particular client's stock can be fetched and displayed on the Virtual Stage with the Temporal Signal. When the narrator in the Temporal Signal switches to a discussion on the weekly performance of the Dow Jones, Enhanced Content presenting related financial performance information can be simultaneously displayed. Thus, it is evident that the present invention profoundly enriches the viewing and/or learning experience and the ease of providing and configuring such an experience.

It is understood that there can exist alternative embodiments for use with the present invention. For example, the client can view the Temporal Signal using a television set or other display monitor in conjunction with the display screen of a client device (for example, a personal computer) presenting the Virtual Stage. In this embodiment, the relevant Enhanced Content is shown on the client device while the Temporal Signal is displayed on the television monitor. In this alternative embodiment, a cable set top box receives the Temporal Signal, for example, a television program, from the multi-channel cable. The client device also receives the Temporal Signal from the multi-channel cable and extracts the URIs, embedded in the VBI of the video signal or directly transmitted over the Internet. The specialized software, as needed, extracts the URIs and retrieves the particular Enhanced Content as described above. The Virtual Stage is then created on the client device and the Enhanced Content related to the Temporal Signal is presented to the client. It is understood that a hyperlink may exist on the Site that will allow the client device to automatically load the specialized software needed to extract URIs from a Temporal Signal, the Virtual Stage and call up the specific television channel referenced in a Site and providing Enhanced Content related to a Temporal Signal.

For example, someone browsing the Internet may come upon a major television network's Web site. They scroll to an interesting story then click on a hyperlink, which provides the software necessary to create a Virtual Stage on their device (if one has already not been created). The Virtual Stage suitably includes a television frame in which the Temporal Signal is presented and another frame (or an Overlay in the Flash environment) in which the Enhanced Content related to the Temporal Signal (or even to a second, non-displayed, Temporal Signal) is displayed. For example, a signal providing a first baseball game's box score may suitably overlay a signal providing the video portion of a second baseball game in the television frame.

Furthermore, instead of receiving Temporal Signals from a transmission means, the Temporal Signals can also be addressed directly from the client site if the Temporal Signal, with or without embedded URIs, is stored on a VHS, Beta, DVD, CD, memory stick or other storage medium. In this embodiment, the client device and/or television are connected to a VCR, DVD, CD player or other appropriate device.

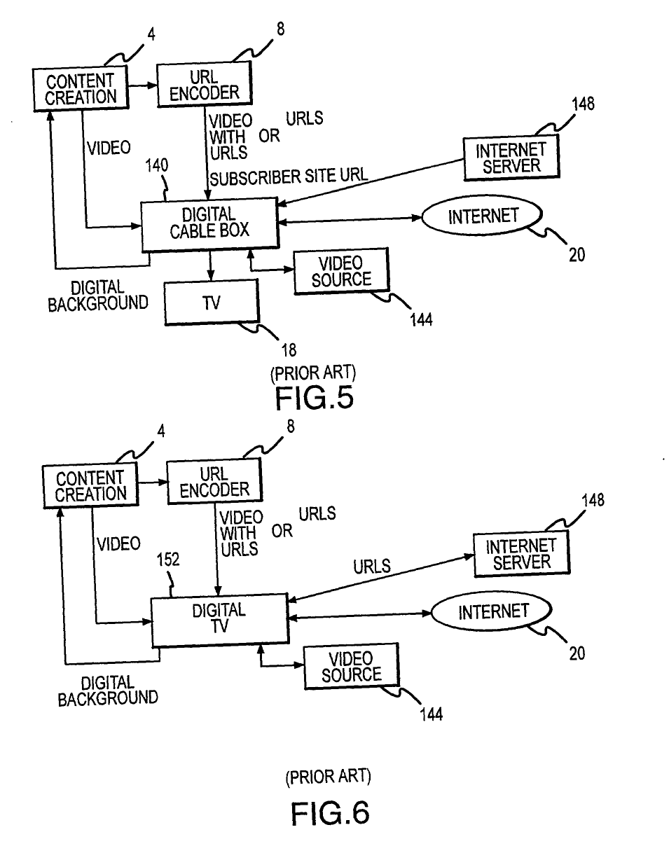

FIGS. 5 and 6 show two alternative embodiments for use with the present invention. For example, the client can view the interactive program using a television set 18 or other display monitor in conjunction with a digital cable box 140, as shown in FIG. 5. In this embodiment, the digital cable box 140 performs the functions of the client device 16 shown in FIGS. 1, 2 and 4. In the embodiment shown in FIG. 5, the specialized software is stored in memory in the digital cable box 140. In one embodiment, the digital cable box 140 includes two tuners, thus allowing both the Enhanced Content, preferably using the Browser, and the Temporal Signal (for example, a video program) to be simultaneously viewed on the same screen. The screen may be configured as one Virtual Stage, or even split in two, wherein a first portion of the screen is configured as a television monitor and a second portion of the screen is configured as the Virtual Stage. If the Temporal Signal and Enhanced Content, however, are carried on one channel, then only one tuner may be necessary.

The specialized software retrieves URIs from the received video program, directly from the Internet connection 20 or via a separate data channel, interprets these URIs and directs the Browser to access the particular relevant Site at which the java script code script elements needed to establish the Virtual Stage are provided. Once the Virtual Stage is established, the digital cable box receives the Enhanced Content that is synchronized to the Temporal Signal for presentation to the client via the television 18, as shown in FIG. 5. In this embodiment, the relevant Enhanced Content is preferably shown in one frame of the television 18 while the video elements of the Temporal Signal are displayed in another frame. Alternatively, the Enhanced Content can replace the Temporal Signal on the display, as desired.

Further, in this alternative embodiment, the digital cable set top box 140 receives the television program from the multi-channel cable. The URIs identifying the location at which the Virtual Stage and/or the Enhanced Content are located is preferably encoded into the digital program channel using MPEG 1, MPEG 2, MPEG 4, MPEG 7 or any other video compression scheme. Alternatively, the URIs can be transmitted to the digital cable boxes 140 from an Internet server 148. The digital cable box 140 decodes the URIs from the digital video signal or directly transmitted over the Internet 20. The specialized software decodes the URIs and retrieves the particular Virtual Stage information and/or Enhanced Content as described above. The Enhanced Content is then preferably synchronized with the particular Temporal Signal and presented to the client on the Virtual Stage.

As with all the embodiments described above, instead of receiving the Temporal Signal from a transmission means, the Temporal Signal can also be obtained directly from a local source 144 if the Temporal Signal, with or without embedded URIs, is stored on a VHS, Beta, DVD, CD, or memory stick, or other recording/storage medium. In this embodiment, the digital cable box 140 is connected to a device capable of communicating the Temporal Signal from a recording/storage medium to a client device, in, for example, the digital cable box 140. System operation then continues, as above, with the Browser contacting the Site, establishing the Virtual Stage and receiving the Enhanced Content related to the Temporal Signal.

FIG. 6 discloses an embodiment wherein a digital TV 152 is the remote reception unit. In this embodiment, the digital TV 152 performs the functions of the client device, shown in FIGS. 1, 2 and 4, and the digital cable box 140 shown in FIG. 5. In the embodiment shown in FIG. 6, a processor and memory are incorporated into the digital TV 152. Further, the specialized software and a Browser are implemented into memory in the digital TV 152. All of the functions described above with reference to the other embodiments are performed in a similar manner by the digital TV 152 embodiment.

Although the digital cable box/TV 140, 18 and digital TV 152, shown in FIGS. 5 and 6, are incorporated into the embodiment of FIG. 1, they also could be substituted for the client device 16 shown in FIGS. 2 and 4.

For example, when the Temporal Signal includes a video portion, the client can view the video and the Enhanced Content on one screen (in two windows), in whole or in part, via the Virtual Stage. Similarly, the Temporal Signal can be viewed on one display screen and the Enhanced Content on a separate display monitor. Alternatively, the client can access the video or Enhanced Content separately. Thus, the client can branch from video to Enhanced Content and vice versa.

The present invention is well-suited to the education environment. In this embodiment, students and teachers access one or more Web servers. The software components include instructor and student user software, authoring software and database assessment software. In one such embodiment, an instructor uses content creation software on a suitable device, for example, a personal computer, to easily integrate into their curriculum current information published on the Web, through an easy to use interface, such as one provided on a Virtual Stage (which in this embodiment is recognized as a “Virtual Classroom”). The instructor creates a lesson (i.e., a Show), the lesson comprising a listing of Web pages, text notes and questions. Further, the Web sites and questions are set forth in a predetermined order and can be assigned times. Preferably, the URIs identifying the Web site and time stamps are sent automatically to the desktop of each student assigned to the Virtual Classroom, either during playback of a pre-recorded program or during a live event.

In the educational embodiment, the Virtual Classroom provides a classroom (much like a real classroom) at which a lesson (the Show) may be presented. Preferably the Virtual Classroom is analogous to an actual classroom in that students may view the classroom (i.e., the Virtual Classroom) regardless of their perspective (i.e., their client device), the time of day, and/or their location. Further, via a Virtual Classroom, the students may interact with the instructor (the Stage Manager) of the lesson. For example, via a chat interface, video images of themselves posing a question to the class may be presented to the Virtual Classroom for all participants to view. As discussed previously, the lesson (i.e., the Show) provides an API through which the instructor may push content, provide and/or allow chats, and establish various rooms in which students may be presented with the assignments, experiments, and various educational materials and/or activities. Since the lesson may be prerecorded and/or live, each student, via their client device, may be part of the Virtual Classroom from a remote location and regardless of the type of device utilized by the student, provided certain minimum requirements are met.

At each of the student devices, the educational program presented on the Virtual Classroom as a lesson is produced/directed by the instructor via pushes from a Site (i.e., a teacher) to the Stage Manager, via the Receiver Object. In other words, the Site (i.e., the teacher) provides the structure for the educational experience. At predetermined times as dictated by the Site, the Browser fetches and displays Enhanced Content segments on the Virtual Classroom. Such segments may be obtained from the Site or an alternative site, as directed by the instructor. Because the lesson can be set up in this manner at predetermined times, the entire lesson can be prerecorded and stored in a Web database for later access by the students. For example, a student having difficulty completing a homework assignment could access the lesson from home and re-learn those elements they missed in class (virtual or real).

A significant advantage of an embodiment for educational applications is that the students and the instructor can be located anywhere, as long as they can be all connected to the lesson via a Virtual Classroom. Similarly, a virtual tutoring environment may also be created. Further, because a teacher is essentially controlling the educational experience, the lesson can take almost any desired form on the Virtual Classroom as presented on the student devices.

Unlike conventional distance learning systems, systems consistent with the present invention are more powerful by allowing the instructor to freely and conveniently exercise almost any type of testing strategy without concern as to the type of devices and/or location of students to the lesson. As such, students connected via wireless devices, computer workstations, or other devices may be suitably connected to the Virtual Classroom. The instructor can test students using a combination of the chat dialogue feature and Enhanced Content. For example, multiple choice questions and short answer questions can appear in the chat section. Essay questions, requiring longer answers, become Enhanced Content frames. As mentioned above, students can perform virtual experiments on-line. Once the instructor's device (for example, a personal computer) receives student answers, student scoring can be presented to the instructor in any format including tables, charts, diagrams, bar graphs, etc. The instructor, thus, can analyze the results and has the capability of providing real-time feedback to the students.

Students can also receive individualized feedback via branched interactive audio, video and/or graphics responses. For example, a student device may branch to a particular audio response contained in a segment of Enhanced Content, preferably prerecorded in the instructor's own voice, based on the student response to a multiple choice question. In this embodiment, a plurality of potential audio responses are made available at the student's device according to any one of the methodologies set forth in, for example, U.S. Pat. No. 5,537,141, entitled DISTANCE LEARNING SYSTEM, which is herein incorporated by reference in its entirety. Alternatively, personalized video, audio and graphics segments can be delivered and displayed to the student based on a student answer or personal profile in the manner set forth in U.S. Pat. No. 5,724,091, entitled COMPRESSED DIGITAL DATA INTERACTIVE PROGRAM SYSTEM, which is herein incorporated by reference in its entirety.

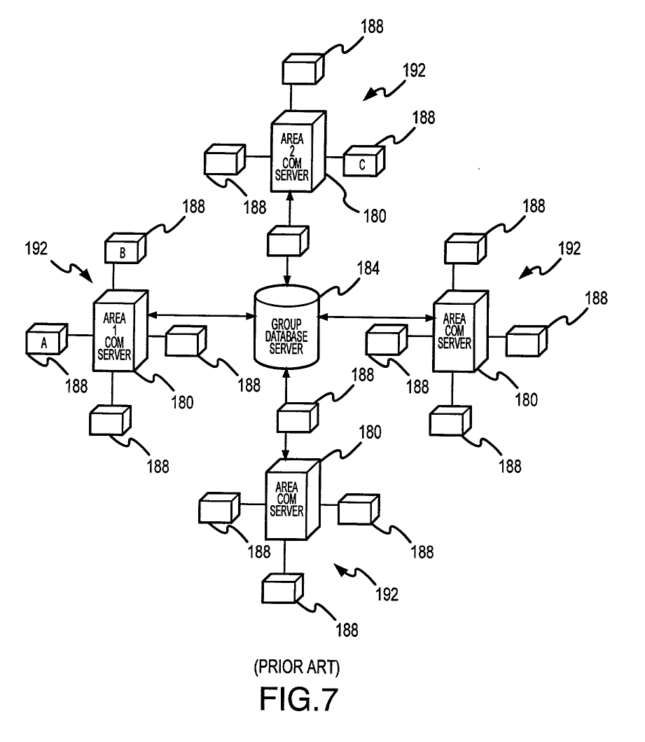

In another embodiment of the present invention, a system is described that is capable of handling the education requirements of several schools utilizing multiple Virtual Classrooms in an efficiently designed network. The system shown in FIG. 7 solves the problems inherent in attempting to service large numbers of users, the most obvious obstacles being the issues of load, performance, and varying types of student devices. In this embodiment shown in FIG. 7, communications servers 180 distribute and route messages across a LAN, WAN and the Internet. Referring to FIG. 7, in the center of the diagram is the Group Database server. Surrounding the database server are several Com Servers 180, each serving an area 192. Surrounding each Com Server 180 are squares representing student devices 188, which are suitably configured with a Virtual Classroom permitting various types of devices to communicate to a Com Server 180, regardless of the communications path(s) utilized. The Communication Servers 180 are organized in node relationships with one another.

Each node is responsible for serving an Area 192. An Area 192 is defined as a virtual location serviced by a single Communications Server 180 (or “Com Server”). An Area 192 may be a single school, an office, or may consist of several actual physical or virtual locations. The defining characteristic of an Area 192 is that messages sent from one member of an Area 192 to another need not be routed outside of the servicing Com Server 180. An Area member is analogous to the frequently used term “student” (or “client”).

The Distributed Communication System of FIG. 7 permits the dynamic addition of Communication Servers 180 within a group with little or no administrative tasks as well as the addition of groups within an overall communications network. A Communication Server group consists of several defined virtual Areas 192 (preferably, consisting of no more the 250 client devices each), each Area 192 serviced by a single Corn Server 180. This system enables client devices of one Area 192, or group to easily communicate with client devices in another Area 192 or group without any configuration changes by using Virtual Classrooms on each student device that are system and configuration independent. As such, a student in one Area 192 (for example, the United States and using a CMDA equipped wireless phone) need not be concerned that their messages are compatible with another student in another Area 192 (for example, a student in Europe using a GSM equipped wireless phone) because the Virtual Classroom on each student's device enables the client to receive messages without regard to the format, provided a communications path between the two can be established which provides a translation service from one communications signal format to another.

Further, service of very large numbers of students has required large expensive servers and networks. As the user base increases, performance suffers and hardware must be upgraded to service the demand.

The Distributed Communication System of the present invention allows the same, relatively inexpensive machines to serve an ever-increasing user base because each student device (preferably configured with a Browser) may utilize a Virtual Classroom that is platform and communications path independent. The technique by which this will be accomplished will be through the routing of messages from one server to another when necessary until it reaches a student device with a Browser and a Virtual Classroom.

The method essentially follows the same core pattern as IP routing and DNS lookups. If a message is for a member not belonging to the current Area 192 or group, the message may be routed through the Distributed Communication System until its destination, or someone who knows the destination and can deliver the message, is found. The destination may be cached so subsequent messages for that student or group of students may be more efficiently delivered, and/or until a Virtual Classroom is established on the specific student's device.

Referring again to FIG. 7, if a message is posted by student “A” and is intended only for the students of group 1 the message preferably never leaves the Area 1 Corn Server. However, if the message is intended for students of Area 1 and Area 2, the Area 1 Com server forwards the message to the group database server 184. The message may be broadcast to the students of Area 1 and tagged in the database 184 as belonging to Area 2. The message may then be routed to Area 2 and broadcast to Area 2 students. With this technique any student can potentially send a message to any other student via the Virtual Classroom or even during a Virtual Chat session (i.e., a session in which a Virtual Stage or Virtual Classroom is primarily configured as a chat room or a similar room for providing video and/or audio communications and interactions between one or more clients). If the Area Com server 180 does not recognize the destination, the message is forwarded up the line. Each Corn server 180 does not need to know about any other server 180. Messages are routed until they are delivered. If undeliverable, the original sender is notified. Since each Corn server 180 may also be equipped with a Virtual Classroom, the need for Corn servers 180 to share a mutual operating platform may be significantly reduced.

New Areas 192 can be added on the fly. When a new Corn server 188 is added to the network, it registers itself with the database application, establishes Virtual Classrooms on its associated student devices, and provides an indication of the type of signals and devices it prefers to receive. Henceforth, any message destined for the new Area 192 can be routed properly without altering the other Area Servers 180. This method and system works for global messages or for student to student messages. Furthermore, new Groups may also be dynamically added. Once added, each new Group Database Server 184 registers itself with the existing database servers 184. This distribution of load permits nearly unlimited expansion with existing software and hardware. Each server manages a finite number of students, cumulatively serving a growing community, for example, a large university.

Students need not be informed as to the particular Corn Server 180 they should connect to. Students are directed to a single URI at which those routines necessary to establish the Virtual Stage/Classroom/Chat room is provided. The selection of the server for user connection is determined by load balancing software. In this manner, the network may appear to be a global network of Servers or simply a local classroom.

The unique aspects of this architecture, using database servers as routing gateways, using techniques resembling IP routing and DNS lookup, and utilizing Virtual Classrooms, where appropriate, to increase interoperability of systems and devices enables this system to serve with minimum administration and configuration and with lower end, cost-effective hardware.

While the present invention has been described in relation to specific systems, hardware, devices, software, platforms, configurations, process routines, and various preferred embodiments, it is to be appreciated that the present invention is not limited to any specific embodiments, process, systems, devices, signal formats, data formats, and/or configurations. As such, the present invention may be considered to cover any and all subject matter, as specified in the attached claims.

1. A computer readable medium providing program code segments for creating a Virtual Stage on a client device, wherein the Virtual Stage provides a platform by which at least one segment of Enhanced Content can be presented to a client via a presentation device, comprising:
a first program code segment providing an abstraction of a Receiver Object, wherein the Receiver Object provides at least one instruction which configures the client device to receive at least one segment of Enhanced Content from an Enhanced Content provider; and
a second program code segment providing an abstraction of a Show, wherein the Show Object provides at least one instruction which configures the client device to present the at least one segment of Enhanced Content;
whereupon establishment of a communications link between the client device and the Enhanced Content provider, the Receiver Object and Show Object configured client device receives the at least one segment of Enhanced Content and presents the received Enhanced Content segments via a presentation device.

2. The computer readable medium of claim 1, wherein the Virtual Stage further comprises a Virtual Classroom.

3. The computer readable medium of claim 1, wherein the Virtual Stage further comprises a Virtual Chat session.

4. The computer readable medium of claim 1, wherein the client device comprises at least one of a personal computer, a personal data assistant, a Web tablet, a wireless communications device, a computer workstation, a gaming console, a set-top box, an Internet equipped television, a digital television, a Browser, a cable box, and a device capable of presenting Enhanced Content to a client.

5. The computer readable medium of claim 1, wherein the presentation device further comprises at least of a television, a video display system, an audio system, a virtual reality system, a gaming system, slow motion video presentation system, a still-frame presentation system, a motion picture presentation system, and a home theater system.

6. The computer readable medium of claim 1, wherein at least one of the first program code segment and the second program code segment provides at least one instruction to configure the client device to receive or present at least one segment of Enhanced Content received in at least one of a hyper-text mark-up language file format, a Flash file format, a dhtml file format, a Java file format, an xml file format, a text file format, a graphic file format, a video file format, and a sound file format.

7. The computer readable medium of claim 1, further comprising:
a third program code segment providing an abstraction of a Subscriber, wherein the Subscriber Object provides at least one instruction which configures the client device to subscribe to at least one subscription.

8. The computer readable medium of claim 7, wherein the at least one instruction configures the client device to subscribe to at least one chat message service.

9. The computer readable medium of claim 1, wherein the computer readable medium is located with at least one of a network server, the client device, the Enhanced Content provider, and a provider of a temporal signal to which the Enhanced Content relates.

10. The computer readable medium of claim 1, further comprising:
a fourth program code segment providing an abstraction of a Control Area, wherein the abstracted Control Area includes at least one Object utilized by the client device to establish interfaces between the client device and at least one Enhanced Content provider.

11. The computer readable medium of claim 1, further comprising:
a fifth program code segment providing a Stage Manager, wherein the Stage Manager controls the creation and operation of the Virtual Stage.

12. The computer readable medium of claim 11, wherein the Stage Manager further comprises at least one instruction for creating a Queue and a Register; wherein the Queue includes a listing of at least one task utilized to configure the client device to present the at least one segment of Enhanced Content and the Register includes an identification of at least one Object and how each of the at least one Object can be contacted.

13. The computer readable medium of claim 12, wherein at least one of the abstracted Show Object and the abstracted Receiver Object are identified as an Object on the Register.

14. The computer readable medium of claim 12, wherein the Register further comprises a table having an Object column and a key column, wherein the Object column identifies a particular Object, and the key column identifies where the particular Object is located.

15. The computer readable medium of claim 14, wherein the Object is located in a memory device that is co-located with at least one of a network server, an Enhanced Content provider, the client device and a provider of a Temporal Signal related to the Enhanced Content.

16. The computer readable medium of claim 12, wherein at least one Object in the Register has a co-dependency with at least one additional Object in the Register.

17. The computer readable medium of claim 16, whereupon adding an Object to the Register, the Register announces the Object to the Queue, and whereupon receiving the announcement, the Queue surveys any listed tasks and directs the Stage Manager to perform those tasks which are awaiting the announcement prior to being executed.

18. The computer readable medium of claim 17, wherein the Stage Manager further comprises an instruction which provides that an Object which is announced last unannounces any other Object competing for a same resource on the client device.

19. A computer readable medium providing program code segments for creating a Virtual Stage on a client device, wherein the Virtual Stage provides a platform by which at least one segment of Enhanced Content can be presented to a client via a presentation device, comprising:
a first program code segment providing an abstraction of a Receiver Object, wherein the Receiver Object provides at least one instruction which configures the client device to receive at least one segment of Enhanced Content from an Enhanced Content provider;
a second program code segment providing an abstraction of a Show, wherein the Show Object provides at least one instruction which configures the client device to present the at least one segment of Enhanced Content; and
a third program code segment providing an abstraction of a Subscriber, wherein the Subscriber Object provides at least one instruction which configures the client device to subscribe to receive the at least one segment of Enhanced Content from the Enhanced Content provider;
whereupon establishment of a communications link between the client device and the Enhanced Content provider, the Receiver Object and Show Object configured client device receives the at least one segment of Enhanced Content, presents the received Enhanced Content segments in accordance with the configuration instructions specified by the Show, and subscribes to at least one of a subscription and a chat room in accordance with the instructions specified by the Subscriber.

20. The computer readable medium of claim 19, wherein the client device further comprises at least one of a personal computer, a personal data assistant, a Web tablet, a wireless communications device, a computer workstation, a gaming console, a set-top box, an Internet equipped television, a digital television, a Browser, a cable box, and a device capable of presenting Enhanced Content to a client.

21. The computer readable medium of claim 19, wherein the presentation device further comprises at least of a television, a video display system, an audio system, a virtual reality system, a gaming system, slow motion video presentation system, a still-frame presentation system, a motion picture presentation system, and a home theater system.

22. The computer readable medium of claim 19, wherein at least one of the first program code segment and the second program code segment provides at least one instruction to configure the client device to receive or present at least one segment of Enhanced Content received in at least one of a hyper-text mark-up language file format, a Flash file format, a dhtml file format, a Java file format, an xml file format, a text file format, a graphic file format, a video file format, and a sound file format.

23. The computer readable medium of claim 19, wherein the Subscriber Object further provides at least one instruction which configures the client device to subscribe to at least one chat message service.

24. The computer readable medium of claim 19, further comprising:
a fourth program code segment providing an abstraction of a Control Area, wherein the abstracted Control Area includes at least one Object utilized by the client device to establish interfaces between the Show Object and the at least one Enhanced Content provider.

25. The computer readable medium of claim 19, wherein the computer readable medium is located with at least one of a network server, the client device, the Enhanced Content provider, and a provider of a Temporal Signal to which the Enhanced Content relates.

26. A computer readable medium providing program code segments for creating a Virtual Stage on a client device, wherein the Virtual Stage provides a platform by which at least one segment of Enhanced Content can be presented to a client via a presentation device, comprising:
a first program code segment providing an abstraction of a Receiver Object, wherein the Receiver Object provides at least one instruction which configures the client device to receive at least one segment of Enhanced Content from an Enhanced Content provider;
a second program code segment providing an abstraction of a Show, wherein the Show Object provides at least one instruction which configures the client device to present the at least one segment of Enhanced Content;
a third program code segment providing an abstraction of a Subscriber, wherein the Subscriber Object provides at least one instruction which configures the client device to subscribe to at least one subscription service;
a fourth program code segment providing an abstraction of a Control Area, wherein the abstracted Control Area contains those elements utilized by the client device to establish interfaces between the client device and at least one Enhanced Content provider; and
a fifth program code segment providing a Stage Manager, wherein the Stage Manager provides at least one instruction which configures the client device to create and operate the Virtual Stage;
whereupon establishment of a communications link between the client device and the Enhanced Content provider, the Receiver Object, Show Object and Subscriber Object configured client device receives the at least one segment of Enhanced Content, presents the received Enhanced Content segments in accordance with the configuration instructions specified by the Show, and subscribes to at least one of a subscription and a chat room in accordance with the instructions specified by the Subscriber.

27. The computer readable medium of claim 26, wherein the Stage Manager provides at least one instruction which controls an order in which an abstraction is created on the client device.

28. The computer readable medium of claim 27, wherein the Stage Manager further comprises at least one instruction for creating a Queue and a Register; wherein the Queue includes a listing of at least one task utilized to configure the client device to present the at least one segment of Enhanced Content and the Register includes an identification of at least one Object and where the at least one Object is located.

29. The computer readable medium of claim 28, whereupon adding an Object to the Register, the Register announces the Object to the Queue, and whereupon receiving the announcement, the Queue surveys any listed tasks and directs the Stage Manager to perform those tasks which are awaiting the announcement prior to being executed.

30. The computer readable medium of claim 29, wherein the Stage Manager provides at least one instruction which controls an order in which the abstraction of the Show, the Control Area, and the Receiver Object are created on the client device.

31. A system for presenting Enhanced Content related to a Temporal Signal to a client via a client device on a Virtual Stage comprising:
a receiver for receiving a Temporal Signal, wherein the Temporal Signal includes at least one URI embedded into the Temporal Signal, the URI providing an address for a Site providing Enhanced Content related to the Temporal Signal;
a decoder, connected to the receiver, for extracting the URI from the Temporal Signal and outputting the URI;
a client device, connected to the decoder, the client device further comprising:
a Browser; and
a storage device;
whereupon receipt of the URI from the decoder, the Browser establishes a connection with the Site and receives from the site a program code which configures the client device as a Virtual Stage by initializing and saving, in the storage device, cross-dependent abstractions of a Show Object and a Receiver Object, wherein the Receiver Object and the Show Object collectively enable the Browser to receive and present the Enhanced Content from any source and via any communications link utilized to communicate the Enhanced Content to the client device.

32. The system of claim 31, wherein the client device further comprises at least one of a personal computer, a personal data assistant, a Web tablet, a wireless communications device, a computer workstation, a gaming console, a set-top box, an Internet equipped television, a digital television, a Browser, a cable box, and a device capable of presenting Enhanced Content to a client.

33. The system of claim 31, wherein the client device further comprises a presentation device, the presentation device further comprising at least of a television, a video display system, an audio system, a virtual reality system, a gaming system, slow motion video presentation system, a still-frame presentation system, a motion picture presentation system, and a home theater system.

34. The system of claim 31, wherein the client device includes at least one instruction to configure the Browser to present at least one segment of Enhanced Content received in at least one of a hyper-text mark-up language file format, a Flash file format, a dhtml file format, a Java file format, an xml file format, a text file format, a graphic file format, a video file format, and a sound file format.

35. A Virtual Stage provided in at least one of a computer readable medium and a propagated signal, for enabling a client device to receive and present at least one segment of Enhanced Content related to a Temporal Signal irrespective of a communications medium utilized to transmit the at least one segment of Enhanced Content from an Enhanced Content provider to the client device, comprising:
a Show Object providing an abstraction of a presentation area in which the Enhanced Content is presented; and
a Receiver Object providing an abstraction of a device capable of receiving the Enhanced Content and providing the received Enhanced Content to the Show Object for presentation to a client via the client device.

36. A memory for storing instructions utilized to configure a presentation space on a client device as a Virtual Stage upon which at least one segment of Enhanced Content may be presented, comprising:
a first data structure stored in a memory, the first data structure including instructions for controlling a presentation space on a client device; and
a second data structure stored in a memory, the second data structure including instructions for configuring the presentation space as a Virtual Stage, further comprising:
an abstracted Stage Manager data Object, wherein the abstracted Stage Manager controls the creation and operation of the Virtual Stage;
a plurality of abstracted Objects, each of said abstracted Objects being utilized to create the Virtual Stage;
an abstracted Queue, in communication with the abstracted Stage Manager, wherein the abstracted Queue comprises a list of tasks to be accomplished and Objects to be abstracted, under the direction of the Stage Manager, in creating and operating the Virtual Stage;
an abstracted Register, in communication with the abstracted Stage Manager and the abstracted Queue, wherein the abstracted Register includes an identification of at least one of the plurality of abstracted Objects and where each abstracted Object is located.

37. The memory of claim 36, wherein the first data structure includes instructions for configuring the presentation space as a Browser.

38. The memory of claim 36, wherein the memory is co-located with at least one of the client device, a network server, a provider of the Enhanced Content, and a provider of a Temporal Signal to which the Enhanced Content relates.

39. The memory of claim 36, wherein at least one of the plurality of abstracted Objects includes an abstracted Receiver Object, wherein the abstracted Receiver Object provides at least one instruction which configures the Browser to receive at least one segment of Enhanced Content.

40. The memory of claim 36, wherein at least one of the plurality of abstracted Objects includes an abstracted Show, wherein the abstracted Show Object provides at least one instruction which configures the Browser to present at least one segment of Enhanced Content.

41. The memory of claim 36, wherein at least one of the plurality of abstracted Objects includes an abstracted Subscriber, wherein the abstracted Subscriber Object provides at least one instruction which configures the Browser to subscribe to at least one subscription service.

42. The memory of claim 41, wherein the at least one subscription service include a chat message service.

43. A process for creating a Virtual Stage on a client device comprising:
abstracting a Show Object, wherein the Show Object provides an abstraction of a platform upon which at least one segment of Enhanced Content provided by a Site may be presented; and
abstracting at least one Receiver Object, in communication with the Show Object, wherein the at least one Receiver Object provides an abstraction of a receiver for receiving from the Site at least one segment of Enhanced Content and providing the received Enhanced Content to the Show Object for presentation on the client device.

44. The process of claim 43, further comprising:
abstracting at least one Subscriber Object, in communication with the Receiver Object, wherein the at least one Subscriber Object provides at least one instruction with configures the client device to subscribe to at least one subscription.

45. The process of claim 44, wherein the at least one subscription includes a subscription to at least one chat message service.

46. A process for creating a Virtual Stage on a client device comprising:
identifying a main frame in the Register, wherein the main frame provides an abstracted framework upon which at least one segment of Enhanced Content may be presented;
identifying a control frame in the Register, wherein the control frame provides an abstracted framework for at least one Object used to control a presentation of Enhanced Content;
abstracting a Show Object, hosted by the main frame, wherein the Show Object provides an abstraction of a platform, upon the abstracted main frame, on which at least one segment of Enhanced Content provided by a Site may be presented; and
abstracting at least one Receiver Object, hosted by the control frame and in communication with the Show Object, wherein the at least one Receiver Object provides an abstraction of a receiver for receiving from the Site at least one segment of Enhanced Content and providing the received Enhanced Content to the Show Object.

47. The process of claim 46, further comprising:
establishing a Queue in a computer readable medium, wherein the Queue provides an indication of a condition and an event that is to be performed when the condition is satisfied;
establishing a Register in a computer readable medium, wherein the Register provides an indication of at least one Object and where each of the at least one Object is located.

48. A process for identifying to an online information provider a type of Enhanced Content to present upon a Virtual Stage comprising:
establishing a communications link between a client device, upon which a Virtual Stage is to present Enhanced Content, and an online information provider; and
communicating a Skin from the client device to the online information provider;
wherein the Skin communicates information indicative of which Enhanced Content the Virtual Stage is to present and an identity of the client device upon which the Virtual Stage is to be established such that the Enhanced Content is compatible with and may be presented on the Virtual Stage hosted by the client device.

49. The process of claim 48, wherein the communications link between the client device and the online information provider is established over at least one of an Internet connection, a wireless link, an intranet connection, a satellite link, a cable link, a dial-up network, a regional network, a broadcast network, a multi-cast network, a simulcast network, and a wired link.

50. The process of claim 49, wherein the client device further comprises at least one of a personal computer, a personal data assistant, a Web tablet, a wireless communications device, a computer workstation, a gaming console, a set-top box, an Internet equipped television, a digital television, a Browser, a cable box, and a device capable of presenting Enhanced Content to a client.

51. An apparatus for executing an application program and being in communication with a database used by the application program to render a Virtual Stage in order to present at least one segment of Enhanced Content on the Virtual Stage comprising:
a processor for processing an application program which configures a presentation space, on a presentation device connected to the processor, for presenting at least one segment of Enhanced Content; and
a memory for storing at least one instruction utilized by the application program to configure the presentation space as a Virtual Stage and further comprising:
an abstracted Stage Manager, wherein the abstracted Stage Manager controls the creation and operation of the Virtual Stage;
a plurality of abstracted Objects, each of said abstracted Objects being utilized to create the Virtual Stage;
an abstracted Queue, in communication with the abstracted Stage Manager, wherein the abstracted Queue comprises a list of tasks to be accomplished and Objects to be abstracted, under the direction of the Stage Manager, in creating and operating the Virtual Stage;
an abstracted Register, in communication with the abstracted Stage Manager and the abstracted Queue, wherein the abstracted Register includes an identification of at least one Object and where the abstracted Object is located;
an abstracted Receiver Object providing at least one instruction which configures the presentation space to receive at least one segment of Enhanced Content;
an abstracted Show Object providing at least one instruction which configures the presentation space to present at least one segment of Enhanced Content.

52. The apparatus of claim 51, wherein the presentation space is controlled by a Browser.

53. The apparatus of claim 51, wherein the memory is co-located with the processor.

54. The apparatus of claim 51, wherein the memory is remotely located with respect to the processor.

55. A signal embodied in a transmission medium for rendering a client device as a Virtual Stage upon which at least one segment of Enhanced Content may be presented to a client, comprising:
a first program code segment providing an abstraction of a Receiver Object, wherein the Receiver Object provides at least one instruction which configures the client device to receive at least one segment of Enhanced Content from an Enhanced Content provider;
a second program code segment providing an abstraction of a Show, wherein the Show Object provides at least one instruction which configures the client device to present the at least one segment of Enhanced Content;
a third program code segment providing an abstraction of a Subscriber, wherein the Subscriber Object provides at least one instruction which configures the client device to subscribe to at least one subscription service;
a fourth program code segment providing an abstraction of a Control Area, wherein the abstracted Control Area contains those elements utilized by the client device to establish interfaces between the client device and at least one Enhanced Content provider; and
a fifth program code segment providing an abstracted Stage Manager, wherein the abstracted Stage Manager provides at least one instruction which configures the client device to create and operate the Virtual Stage;
whereupon establishment of a communications link between the client device and the Enhanced Content provider, the Receiver Object, Show Object and Subscriber Object configured client device receives the at least one segment of Enhanced Content, presents the received Enhanced Content segments in accordance with the configuration instructions specified by the Show, and subscribes to at least one of a subscription and a chat room in accordance with the instructions specified by the Subscriber.
